(19) United States
(12) Patent Application Publication
(10) Pub. No.: US 2012/0034884 A1
(43) Pub. Date: Feb. 9, 2012

(54) MOBILE PHONE

(75) Inventor: Takeshi Sekine, Kanagawa (JP)

(73) Assignee: PANASONIC CORPORATION, Osaka (JP)

(21) Appl. No.: 13/265,224

(22) PCT Filed: Nov. 25, 2009
(86) PCT No.: PCT/JP2009/006334

§ 371 Date: Oct. 19, 2011

(30) Foreign Application Priority Data
Apr. 30, 2009 (JP) 2009-110552

(51) Int. Cl. H04W 88/02

(52) U.S. Cl. 455/90.3

(57) ABSTRACT

A mobile phone includes: an insert metal plate; a pin fixed to the insert metal plate; and a resin portion. The resin portion is formed by insert molding and covers a peripheral edge of the insert metal plate such that an end surface of the pin is exposed.

### TECHNICAL FIELD

The invention relates to a mobile phone, particularly to an electrical connection between a built-in antenna and a circuit board, and a waterproof structure of a component accommodating portion which accommodates the circuit board, electronic components and the like.

### BACKGROUND ART

A related-art mobile phone is known (for example, see Patent Document 1). A built-in antenna member of the mobile phone includes a plurality of antennas and waterproof packing in which bent portions provided in the vicinity of power feed portions of the plurality of antennas are embedded. The plurality of antennas are arranged between an inner housing which stores a circuit board and an outer housing which covers the inner housing. The power feed portions of the plurality of antennas are led into the inner housing through antenna holes provided in the inner housing, and contact and are electrically connected to spring terminals of the circuit board. The antenna holes are sealed in a watertight manner by the waterproof packing in which the plurality of antennas are embedded.

### RELATED ART DOCUMENTS

### Patent Documents

Patent Document 1: JP-A-2008-11116

### SUMMARY OF THE INVENTION

### Problem to be Solved by the Invention

In a waterproof structure for the built-in antenna and a storage recess storing therein the circuit board of the related-art mobile phone described in the patent Document 1, it is necessary to use a dedicated member as the built-in antenna and also to embed the antenna member into the waterproof packing, whereby the manufacturing cost of the components is increased. Further, since it is necessary to use the waterproof packing to ensure the watertight of the antenna hole, there is a problem that it becomes difficult to minimize the device.

In addition, in a waterproof structure for a built-in antenna and a component accommodating portion of a mobile phone shown in FIG. 5, if an insert metal plate, which defines the bottom surface of the component accommodating portion, is used as the built-in antenna, it is not necessary to use a dedicated member as the built-in antenna.

However, in order to electrically connect the insert metal plate having an antenna function with the circuit board (not shown) by an antenna spring plate, it is necessary to form an opening portion, through which the insert metal plate is exposed, in a part of a resin portion which is formed by insert molding.

Since the contacting regions (in the area B of FIG. 5) of the insert metal plate and the resin portion which is formed by insert molding have different material and are not fused, a small gap occurs due to the change of ambient temperature, molding shrinkage and the like, and there is a problem that water enters into the component accommodating portion through the small gap.

The invention was made to solve the problems of the conventional mobile phone, and an object thereof is to provide a mobile phone capable of electrically connecting a built-in antenna of the mobile phone with a circuit board reliably and capable of reducing the number of components and realizing an the minimization of the device without a use of a dedicated waterproof packing for preventing water from entering into a component accommodating portion which accommodates the circuit board, electronic components and the like, and a use of a dedicated antenna member.

### Means for Solving the Problem

A mobile phone of the invention includes: an insert metal plate; a pin fixed to the insert metal plate; and a resin portion which is formed by insert molding and which covers a peripheral edge of the insert metal plate such that an end surface of the pin is exposed.

With this configuration, in the mobile phone, a built-in antenna in a housing can be electrically connected with a circuit board, and water can be prevented from entering into a component accommodating portion which accommodates the circuit board, electronic components and the like.

In the mobile phone of the invention, the pin has a cylindrical shape.

With this configuration, in the mobile phone, by using molding shrinkage of the resin, water can be prevented from entering through a boundary portion between the resin portion formed by insert molding and a surface of the pin.

In the mobile phone of the invention, the pin has a groove portion formed at a side surface of the pin.

With this configuration, in the mobile phone, water can be prevented from entering through a boundary portion between the resin portion formed by insert molding and the surface of the pin.

In the mobile phone of the invention, the pin includes a thread portion.

With this configuration the built-in antenna in the housing can be electrically connected with the circuit board, and water can be prevented from entering into the component accommodating portion which accommodates the circuit board, the electronic components and the like.

### ADVANTAGES OF THE INVENTION

A mobile phone of the invention includes an insert metal plate, a pin fixed to the insert metal plate, and a resin portion which is formed by insert molding and which covers a peripheral edge of the insert metal plate such that an end surface of the pin is exposed. Accordingly, the invention can provide a mobile phone with advantages capable of electrically connecting a built-in antenna of the mobile phone with a circuit board reliably, and capable of reducing the number of components and realizing an the minimization of the device without a use of a dedicated waterproof packing for preventing water from entering into a component accommodating portion which accommodates the circuit board, electronic components and the like, and a use of a dedicated antenna member.

### BRIEF DESCRIPTION OF THE DRAWINGS

FIG. 1(a) is a front view showing a state in which a foldable mobile phone according to an embodiment 1 of the invention is folded, FIG. 1(b) is a front view showing a state in which the mobile phone is opened by a first hinge, and FIG. 1(c) is a front view showing a state in which the mobile phone is opened by a second hinge.

FIG. 2 is a cross-sectional view of a main portion taken in the direction of arrows A-A of FIG. 1(c) in the embodiment 1 of the invention.

FIG. 3 shows a first modification of a pin of the embodiment 1 of the invention.

FIG. 4 shows a second modification of the pin of the embodiment 1 of the invention.

FIG. 5 is a cross-sectional view of a main portion of an example which has problems.

### MODE FOR CARRYING OUT THE INVENTION

Mobile phones according to the embodiments of the invention are described with reference to the drawings.

### Embodiment 1

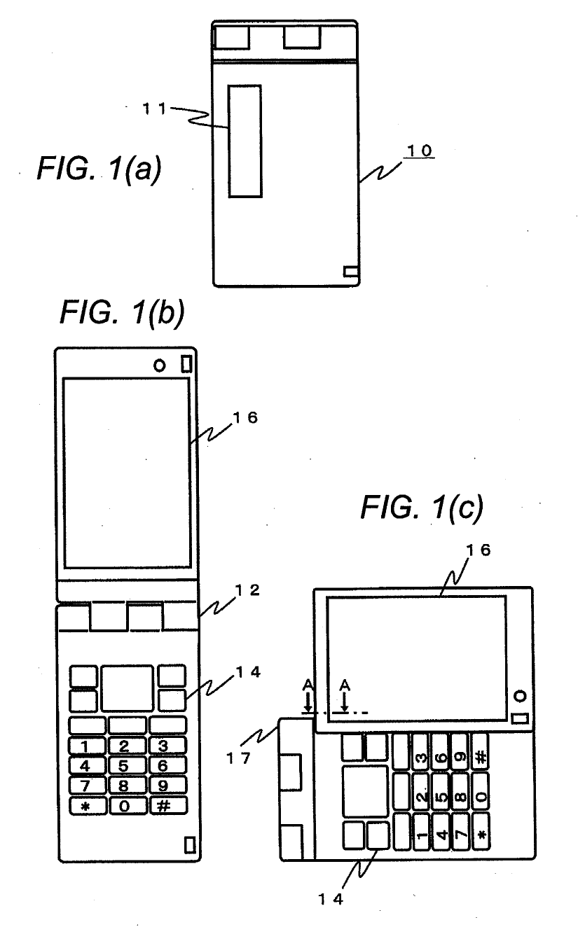

FIG. 1 shows a foldable mobile phone 10 according to the embodiment 1 of the invention.

FIG. 1(a) is a front view showing a state in which the foldable mobile phone 10 is folded. The foldable mobile phone 10 includes a sub-display unit 11 including a liquid crystal display panel or an electroluminescence display panel.

FIG. 1(b) is a front view showing a state in which the foldable mobile phone 10 is opened in a longitudinal direction by a first hinge 12. In the foldable mobile phone 10, an operating unit 14 including a keypad is provided in a first housing, and a main display unit 16 including a liquid crystal display panel or an electroluminescence display panel is provided in a second housing.

FIG. 1(c) is a front view showing a state in which the foldable mobile phone 10 is opened in a lateral direction by a second hinge 17, and the main display unit 16 becomes a rectangle mode which is suitable for TV watching.

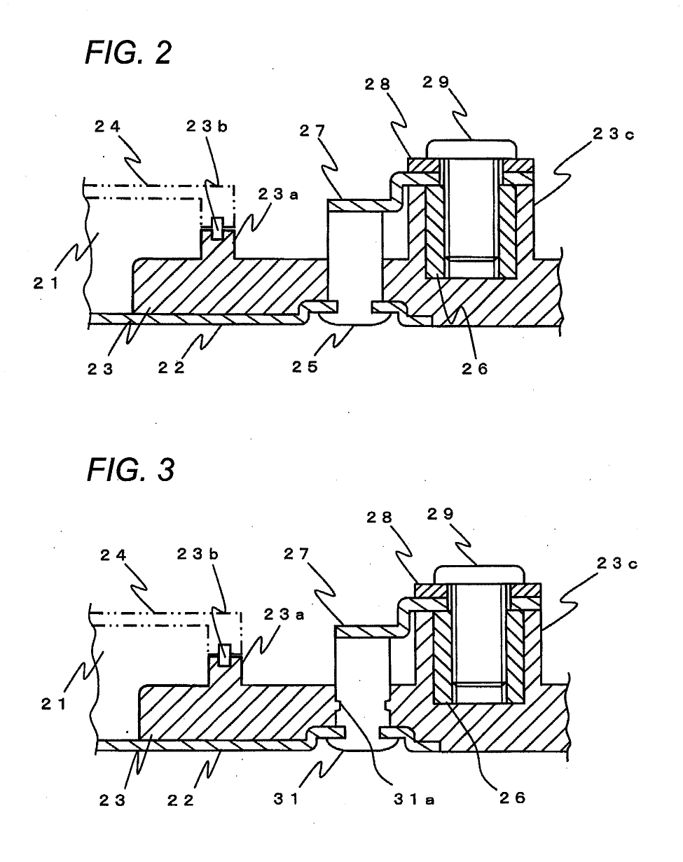

The internal structure of the foldable mobile phone having the above structure is described with reference to FIGS. 2 to 4.

FIG. 2 is a cross-sectional view of a main portion taken in the direction of arrow A-A of FIG. 1(c).

In FIG. 2, a component accommodating portion 21 accommodates a circuit board, electronic components (not shown) and the like for driving and controlling a display element (the main display unit 16 or the sub-display unit 11) including a liquid crystal display panel, an electroluminescence display panel or the like.

An insert metal plate 22, which is insert molded, has a function of a digital television antenna, and a resin portion 23 covers a peripheral edge of the insert metal plate 22 and a part of a surface of the insert metal plate 22.

A packing fitting groove 23b is formed at a distal end surface of a projection 23a protruding from the resin portion 23. In addition, a pressing member 24 presses an entire circumference of a packing member (not shown) attached to the packing fitting groove 23b.

In this way, the component accommodating portion 21 is defined by the insert metal plate 22, the resin portion 23, the packing fitting groove 23b and the pressing portion 24, thereby ensuring waterproofing.

The insert metal plate 22 is used as a ground of the housing. In addition, by feeding power from a feed point to the insert metal plate 22 serving as the ground of the housing, the housing can be used as a so-called housing dipole antenna, for example, the digital television antenna.

The metal cylindrical pin 25 is fixed to the insert metal plate 22 by riveting or stud welding, and the end surface of the pin 25 is exposed from the surface of the resin portion 23 formed by insert molding.

A cylindrical boss portion 23c is formed in the vicinity of the pin 25, and an insert nut 26 is pressed fitted in the boss portion 23c or formed by insert molding.

A flexible antenna spring plate 27 has a contact point (not shown) on a flat surface portion of a distal end of the antenna spring plate 27. A metal hinge attachment piece 28 is electrically connected with the circuit board (not shown). The antenna spring plate 27 and the hinge attachment piece 28 are overlaid and fastened together by a screw 29 to the insert nut 26. Then, the contact point (not shown) of the flat surface portion of the distal end of the antenna spring plate 27 contacts the end surface of the pin 25, and the antenna spring plate 27 is urged and attached.

As described above, according to the foldable mobile phone of the embodiment, the component accommodating portion for accommodating the circuit board, the electronic components and the like includes a bottom surface defined by the insert plate having the digital television antenna function, a side surface defined by the resin portion integrally formed with the insert metal plate, and an upper surface defined by the pressing member for pressing an entire circumference of the packing member. Accordingly, air tightness is achieved.

In addition, since the contact point (not shown) of the flexible antenna spring plate fastened together with the metal hinge attachment piece connected to the circuit board (not shown) is urged and contacts the end surface of the metal pin fixed to the insert metal plate having the digital television antenna function, the insert metal plate having the digital television antenna function can be electrically connected with the circuit board (not shown) reliably.

Further, since the metal pin fixed to the insert metal plate has a cylindrical shape, the side surface of the pin is secured uniformly from periphery by virtue of shrinkage of the insert molding. Accordingly, the seal between the resin and the surface of the pin becomes stronger. Consequently, water can be prevented from entering from the sealed portion. In addition, if the resin is shrunk uniformly in the insert molding, the shape of the metal pin is not limited to circular in cross section (i.e., cylindrical shape) and may be oval in cross section or polygonal in cross section (i.e., prism shape).

Since the insert metal plate defining the bottom surface of the component accommodating portion is used as the digital television antenna, it is not necessary to use the dedicated member for the built-in antenna. Since the resin portion is used for covering the peripheral edge of the insert metal plate and the periphery of the pin by insert molding, it is not necessary to use the packing member. Therefore, the number of the components can be reduced and the minimization of the device can be realized.

FIG. 3 shows a first modification of the pin in the embodiment 1 of the invention.

In FIG. 3, the identical reference numerals are given to parts with the same configuration as those shown in FIG. 2, and their descriptions are omitted.

A groove portion 31a is formed in a side surface of a metal cylindrical pin 31 fixed to the insert metal plate 22 having the digital television antenna function by riveting or stud welding. The end surface of the pin is exposed from the resin surface of the resin portion 23 formed by insert molding.

According to the first modification of the pin of the embodiment 1 of the invention, since the metal pin fixed to the insert metal plate has a cylindrical shape, and the groove portion is formed in the side surface of the pin, the side surface of the pin is secured uniformly from periphery by virtue of shrinkage of the insert molding, and a contact length between the surface of the pin and the resin portion becomes longer because of the groove portion. Accordingly, the seal between the resin and the surface of the pin becomes stronger. Consequently, water can be prevented from entering from the sealed portion.

In the above embodiment, one groove portion is formed in the side surface of the pin. However, the invention is not limited thereto, and a plurality of groove portions may be formed in the side surface of the pin.

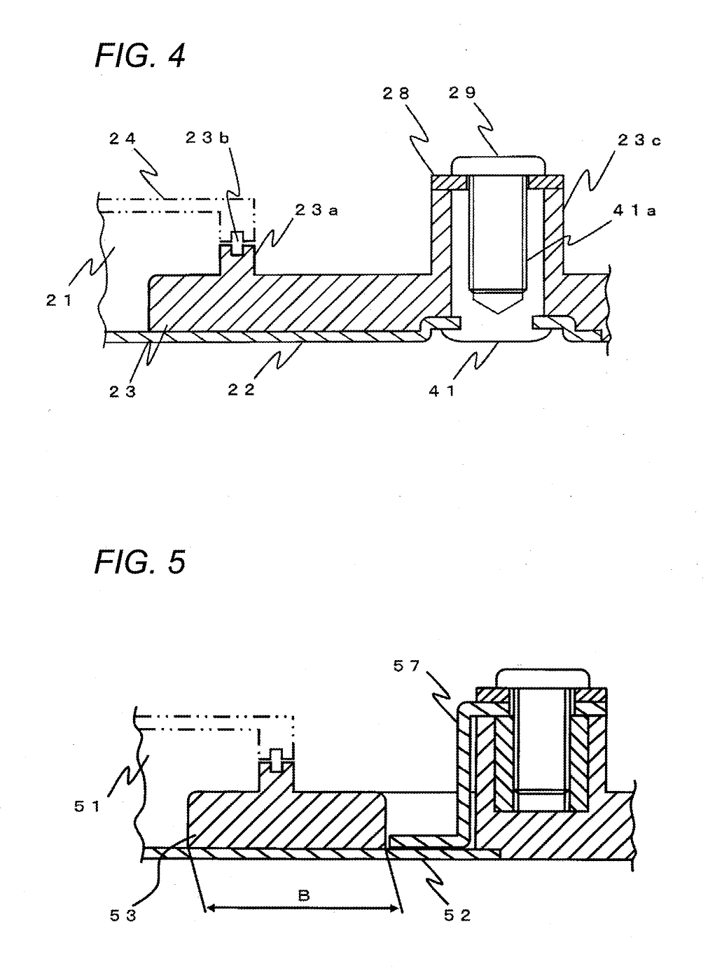

FIG. 4 shows a second modification of the pin in the embodiment 1 of the invention.

In FIG. 4, the identical reference numerals are given to parts with the same configuration as those shown in FIG. 2, and their descriptions are omitted.

A metal cylindrical pin 41 includes a thread portion 41a at its end surface, and is fixed to the insert metal plate 22 having the digital television antenna function by riveting or stud welding. The end surface of the pin 41 is exposed since it is not covered by the resin portion 23 formed by insert molding.

The metal hinge attachment piece 28, which is electrically connected with the circuit board (not shown), is fastened to the thread portion 41a of the pin 41 by the screw 29.

According to the second modification of the pin of the embodiment 1 of the invention, the metal hinge attachment piece electrically connected with the circuit board (not shown) is fastened to the end surface of the pin fixed to the insert metal plate having the digital television antenna function by the screw. Accordingly, the insert metal plate having the digital television antenna function can be electrically connected with the circuit board (not shown) reliably without the flexible antenna spring plate, and it is not necessary to use the insert nut for ensuring the connecting strength. Therefore, the number of the components is reduced, and the price of the device is lowered.

Although the foldable mobile phones is described in the above embodiments, but the invention is not limited thereto, and may be applicable to bar-type mobile phones and slide-type mobile phones. Further, the invention does is not limited to mobile phones, and may be applicable to PDAs or other mobile terminal devices.

Although the present invention is described in detail with reference to the embodiments, it is apparent to those skilled in the art that various changes or modifications may be made without departing from the spirit and scope of the invention.

This application is based on the Japanese patent application (Application No. 2009-110552) filed on Apr. 30, 2009, the contents of which are incorporated herein by reference.

### INDUSTRIAL APPLICABILITY

The invention provides advantages capable of electrically connecting a built-in antenna in the housing with the circuit board reliably, realizing minimization of the device without using a dedicated waterproof packing element, and preventing water from entering into the component accommodating portion which accommodates the electronic components, and is useful for mobile phones.

### DESCRIPTION OF REFERENCE SIGNS

10: mobile phone
11: sub-display unit
12: first hinge
14: operating unit
16: main display unit
17: second hinge
21: component accommodating portion
22: insert metal plate
23: resin portion
23a: projection
23b: packing fitting groove
23c: boss portion
24: pressing member
25, 31, 41: pin
26: insert nut
27: antenna spring plate
28: hinge mounting sheet
29: screw
31a: groove portion
41a: thread portion

1. A mobile phone comprising:
an insert metal plate;
a pin fixed to the insert metal plate; and
a resin portion which is formed by insert molding and which covers a peripheral edge of the insert metal plate such that an end surface of the pin is exposed.

2. The mobile phone according to claim 1, wherein the pin has a cylindrical shape.

3. The mobile phone according to claim 1, wherein the pin has a groove portion formed in a side surface of the pin.

4. The mobile phone according to claim 1, wherein the pin comprises a thread portion.

5. The mobile phone according to claim 1, wherein the insert metal plate configures a housing dipole antenna.
